(19) United States
(12) Patent Application Publication
(10) Pub. No.: US 2022/0079186 A1
(43) Pub. Date: Mar. 17, 2022

(54) LIQUID COMPOSITION COMPRISED OF A MICELLAR CASEIN CONCENTRATE

(71) Applicant: AUSNUTRIA B.V, Zwolle (NL)

(72) Inventors: Wolf Harald ROMBOUTS, Zwolle (NL); Frédéric BENJAMINS, Zwolle (NL); Mattia BOIANI, Zwolle (NL); Randolph Peter HAPPE, Zwolle (NL); Alfred Jacques HAANDRIKMAN, Zwolle (NL)

(73) Assignee: AUSNUTRIA B.V, Zwolle (NL)

(21) Appl. No.: 17/418,319

(22) PCT Filed: Dec. 24, 2019
(86) PCT No.: PCT/NL2019/050876

§ 371 Date: Jun. 25, 2021

(30) Foreign Application Priority Data
Dec. 28, 2018 (NL) 2022324

(51) Int. Cl. A23J 1/20; A23L 27/24; A23C 9/15; A23C 9/142

(52) U.S. Cl. CPC A23J 1/202; A23C 9/1422; A23C 9/1512; A23L 27/25

(57) ABSTRACT

A liquid composition comprised of a micellar casein concentrate (MCC), more specifically a MCC that is of non-bovine origin. Food products comprised of the liquid composition and methods for the production of the liquid composition of present invention.

The present invention relates to a liquid composition comprised of a micellar casein concentrate (MCC), more specifically a MCC that is of non-bovine origin. The present invention further relates to food products comprised of the liquid composition of present invention and methods for the production of the liquid composition of present invention.

Micellar caseins are milk proteins naturally rich in casein and minerals e.g. calcium and phosphor. Micellar caseins are commonly used in the food and beverage industry for their texturizing properties, and are also used to enrich food products with protein. One of the main challenges in the development of new products that comprise a high level of protein, is that the high protein content will not adversely affect the texture, taste and nutritional benefit of the food product. In milk based nutrition applications, micellar caseins are being used to achieve high protein contents, enriching the food product while maintaining the properties, such as the texture, of the product.

A drawback of liquid food products comprised of (enriched) high protein content is that the viscosity is negatively affected by an increase of protein. In some cases increasing the amount of proteins may even lead to precipitation and sedimentation of these proteins and other ingredients present in composition of the food product, such as lipids and carbohydrates. Individuals such as patients suffering from dysphagia or tube-fed patients, people with reduced appetite, and elderly having a diminished ability to consume products, require to obtain their nutrition or nutrition supplements in the smallest volume possible. Ingesting larger volumes of liquid product often may result in reduced therapy compliance, or leading to suboptimal nourishment, and in the long run result in malnutrition. Therefore, liquid nutritional compositions that target this specific group of patients are nutrient-dense (high protein/carbohydrate/fat) to meet the daily intake of macronutrients. The above group of patients preferably need small volume, liquid, high nutrition value compositions. Commonly, such products are further fortified with certain micronutrients such as vitamins and minerals.

Special care is taken with respect to the protein levels in these nutritional compositions. An important issue of these nutrient-dense compositions, is the inherent increase in overall viscosity due to the required increase in protein content. This increase in viscosity makes the food product difficult to consume and might result in difficulty for the patients to swallow the product, or to maintain a stable flow rate for patients that are tube-fed. A commonly known strategy to achieve a product with high protein content that has an acceptable viscosity, is the incorporation of hydrolysates, peptides and/or free amino acids, these additions however have a negative impact on the taste of the product with respect to its bitterness. In addition, during processing of food products that are high in protein content—and having high viscosity, issues arise with respect to the solvability of the product (e g a milk powder produced from the liquid composition) in small volumes to reach high protein content.

Considering the above, there is a need in the art for providing a composition that can be used in a food product that is high in protein content, wherein the composition that is high in protein content remains sufficiently low in viscosity such that the composition is easy to consume, ingest and digest, and wherein the high protein content does not affect the taste of the composition, and can meet the nutritional needs of an individual. Furthermore, the composition of present invention remains easy to process, not requiring further processing steps, such as hydrolysing the proteins to lower viscosity or add free amino acids, to obtain high protein levels while maintaining low viscosity of the composition to allow the composition to be easily consumed or administered.

It is an object of the present invention, amongst other objects, to address the above need in the art. The object of present invention, amongst other objects, is met by the present invention as outlined in the appended claims.

Specifically, the above object, amongst other objects, is met, according to a first aspect, by the present invention by a liquid composition consisting of a micellar casein concentrate (MCC) of goat origin, wherein the MCC comprises between 60 to 90 wt % protein, more preferably between 75 to 90 wt %, based on total dry weight of the composition wherein the composition has a dynamic viscosity of at most 100 mPa·s, wherein the MCC comprises a casein to whey ratio of at least 85:15 and wherein the composition has a pH of between 6.5 to 7.2. The composition of present invention is high in protein content due to the presence of concentrated micellar casein, to obtain an end-product with a sufficiently low viscosity that requires no further processing. Furthermore, for the composition of present invention there is no need to include caseinate or protein hydrolysate to lower the viscosity of the liquid formulation.

Surprisingly the liquid composition of present invention, comprising non-bovine micellar casein concentrate i.e. a goat MCC exhibits a significantly lower viscosity than the solutions containing the bovine MCC at the same experimental conditions, especially at high protein content (12 wt %) and pH values ≥6.6 to 7.2. Formulation of liquid compositions comprising a high protein content (at least 8 wt %) can be achieved using goat MCC in-stead of bovine MCC, which is beneficial for high-protein ready-to-drink products. Furthermore, the processing required to prepare nutrient-dense high protein content liquid compositions comprising goat MCC is much easier than compared to in the case when using bovine MCC.

Another benefit of the non-bovine MCC, for example goat MCC versus bovine MCC, is the ease of digestion. This difference in casein digestibility might be explained by the curd structure formed in the stomach after its ingestion. Goat caseins tend to form softer, more fragile curds when compared to cow caseins. This weaker structure of the goat curd leads to an increased accessibility to digestive enzymes, and therefore faster digestion of goat casein curds. Goat MCC is expected also to have a faster gastric emptying than cow MCC because of its weaker curd, thereby facilitating the digestion of the goat MCC protein. Lowering the degree of phosphorylation of cow caseins by enzymatic treatment leads to decreased gastric clotting. Curd formation does not occur during digestion of human milk Cow and goat milk do lead to gastric clotting, but it is assumed that goat milk form softer and smaller curds. Therefore, it is hypothesized that the variation in gastric clotting between human, goat and cow milk, is to a certain extent the result of differences in the degree of phosphorylation of the caseins.

Non-bovine MCC are beneficial to increase the protein content of the composition, while maintaining the low viscosity of the composition and without diminishing the taste of the product. These differences in contributions to the viscosity per MCC originating from different origin seem to be related to differences in the degree of glycosylation between the x-caseins in goat, sheep and cow milk A considerable amount of water in the bovine casein micelles is present in the “hairy” x-casein layer. The glycosylation of the glyco-macro-peptide region of the x-caseins ensures higher hydrophilicity, which in turn translates into higher water retention in the hairy layer. This increases the overall hydration and voluminosity of the bovine casein micelles, thereby also increasing the viscosity. In contrast, caprine (goat) and ovine (sheep) x-casein is known to have lower levels of glycosylation, which explains the lower voluminosity of the goat proteins, and implicitly the lower viscosity measured in this study. The liquid composition of present invention comprising goat MCC at a pH between 6.6 to 7.2 having a protein voluminosity of between 4 to 5 mL/g at protein content of 3.5 wt %, or has a protein voluminosity of between 4 to 6 mL/g, preferably 4.5 to 5.5 mL/g at protein content of 8.0 wt %, or has a protein voluminosity of between 4 to 5.5 mL/g, preferably 4.5 to 5 mL/g at protein content of 12.0 wt %.

The liquid composition has a dynamic viscosity of at most 100 mPa·s, preferably at most 50 mPa·s, more preferably at most 25 mPa·s, at 20° C. and a shear rate of 100 s⁻¹. The viscosity of the liquid composition of present invention can be determined for example by using a rheometer. A sufficiently low viscosity (i.e. <100 mPa·s at 20° C. and a shear rate of 100 s⁻¹), such that it allows patients suffering from ingestion difficulties, such dysphagia, tube-fed patients (or babies), and people with reduced appetite and require to obtain their nutrition in the smallest volume possible. At the viscosity of present invention the product remains easy to ingest, i.e. remains liquid, while at the same time the protein content remains high. This results in an increase in therapy compliance and decrease in the chance of malnutrition.

The MCC of the composition of present invention comprises a casein to whey ratio of at least 85:15, preferably at least 90:10, more preferably at least 95:5, even more preferably at least 97:3, most preferably at least 99:1. In contrast to casein not in its micellar structure, the micellar casein concentrate (MCC) has an intrinsic low viscosity and a liquid composition comprising said MCC are therefore easy to consume or administer.

According to yet another preferred embodiment, the present invention relates to the liquid composition wherein the composition further comprises between less than 50 wt %, preferably less than 25 wt %, more preferably less than 1 wt % of lactose based on total dry weight of the composition.

According to a preferred embodiment, the present invention relates to the liquid composition wherein the composition is further comprised of a surfactant and/or emulsifying agent, such as soy lecithin. The reconstitution properties and the emulsification capacity of the composition of present invention can be improved by addition of one or more emulsifying agents and/or surfactants, such as soy lecithin or modifications thereof e.g. lecithination.

The liquid composition of present invention has a pH of between 6.5 to 7.2. The viscosity of the liquid composition decreases with decreasing pH due to a decrease in the net negative charges of the caseins, which imply a decrease in the intra-micellar electrostatic repulsion, with consequent decrease in voluminosity and in viscosity. However, decreasing the pH of the liquid composition ultimately leads to complete solubilisation of the colloidal calcium phosphate (CCP) from the casein micelles, which results in loosening of the micellar structure, increased voluminosity and therefore increased viscosity. Decreasing the pH further below the dissolution of CCP and closer to the isoelectric point of the caseins leads to gelation of the system as a result of electrostatic interactions between the caseins. Preferably the pH of the liquid composition of present invention is between 6.6 and 7.2. Based on the current data, at pH values above 7.2 the goat MCC is expected to have lower viscosity than the corresponding cow reference.

The present invention, according to a second aspect, relates to a food product, wherein said food product is a powder comprised of a micellar casein concentrate (MCC) of goat origin, wherein the MCC comprises between 30 to 90 wt % protein, based on total dry weight of the MCC, and wherein the MCC comprises a casein to whey ratio of at least 85:15 and has a pH of between 6.5 to 7.2, and wherein the food product comprises at least 8 wt % protein based on total dry weight of the food product. The composition of present invention can be used as ingredient in various food product applications. Instant powder formulation such as infant formula, follow-on formula, pregnancy foods, elderly food, sports food, dietary foods, ice cream, and milk or dairy products having increased protein content. In these products the skimmed milk or whole milk powder of bovine origin can be (partially) replaced by the composition of present invention. Ready-to-drink products (medical, adult, sports) are generally nutrient-dense (high carb and/or high protein and/or high fat), in which a low viscosity of the end-product with regard to swallowability and acceptability is critical. The composition of present invention can also be used as ingredient of protein bars. From a nutritional perspective this is beneficial due to its high content of branched-chain amino acids, and due to the prolonged release of amino acids when compared to whey proteins that are often present in such protein bars. The food product comprises at least 8 wt %, more preferably at least 12 wt %, most preferably 25 wt % protein based on total dry weight of the food product. The food product of present invention is a powder. The composition of present invention is processed such that it is in powdered state, and can for example be sold as infant formula.

According to a preferred embodiment, the present invention relates to the food product, wherein the MCC comprises less than 1 wt % of lactose based on total dry weight of the MCC.

According to yet another preferred embodiment, the present invention relates to the food product, wherein the food product is one or more selected from the group consisting of instant powder formulations, infant formula, sport drinks, cheese, yogurt, protein bars, ice cream, medical nutrition, elderly nutrition, and tube feeding.

The present invention, according to a further aspect, relates to a method wherein the method comprises the steps of,

a) heat treating of goat milk, wherein the milk has a fat content of at most 0.1 wt %, and wherein by heat treating a soluble casein fraction of the milk is reduced to a concentration of between 1 to 6%, preferably 1.5 to 5.5%, more preferably 2 to 4%, most preferably 2.5 to 3%, based on the total casein content in the milk.

b) microfiltration of heat treated milk providing a permeate and a retentate, wherein the retentate comprises a micellar casein concentrate,

c) collecting the retentate comprised of the micellar casein concentrate.

As non-bovine (e.g. goat) milk has smaller fat globules, optimal skimming conditions of non-bovine milk differ from those of bovine milk. The fat content of the non-bovine milk used in the method of present invention as input for the process is important and the fat content should not exceed 0.1 wt %, because this would result in that the microfiltration process will be less efficient. The casein is in its natural native micellar form due to minimal processing. A distinctive microfiltration process is used, which ensures a high concentration of the micellar casein protein.

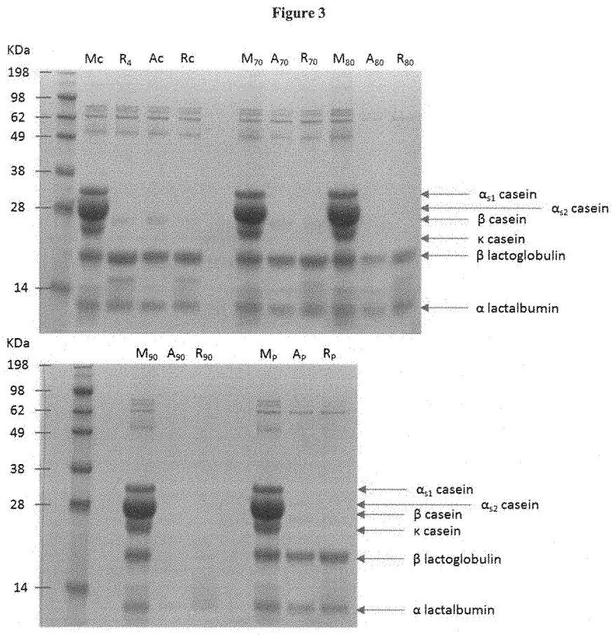

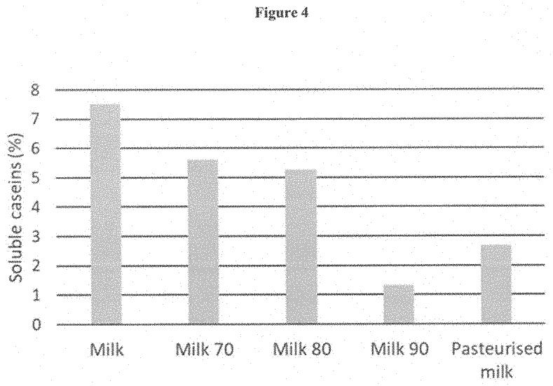

Step a) in the method of present invention, is the heat treatment of the non-bovine milk prior to microfiltration (step b), to reduce the soluble fraction of casein proteins and increase the process selectivity. When no heat treatment is performed, e.g. in unprocessed goat milk, a part of the milk caseins is soluble (=soluble fraction). Therefore these soluble caseins move to the permeate when performing microfiltration (step b). This will result in losses of these soluble caseins in the retentate. In the method of present invention, it was found that when heating (step a) the non-bovine milk, the soluble casein fraction is reduced and that the reduction is more pronounced at increasing temperatures (see FIGS. 3 and 4). Therefore, when performing microfiltration (step b) afterward, the retention of casein in the retentate (containing the MCC) is improved, thereby optimizing the whole process. By heat treating the soluble casein fraction of the milk is reduced to a concentration of between 1 to 6%, preferably 1.5 to 5.5%, more preferably 2 to 4%, most preferably 2.5 to 3%, based on the total casein content in the milk A significant reduction of the soluble casein fraction can be achieved when heat-treating the non-bovine milk according to the method of present invention. This step of heating the goat milk results in a more efficient process, i.e. up to 10% of additional casein in the milk will remain in the retentate, which is otherwise lost via the permeate as soluble fraction.

According to a preferred embodiment, the present invention relates to the method, wherein the method further comprises at least one additional step d) of concentrating the retentate of step b) to obtain a micellar casein concentrate comprised of at least 75 wt % protein, based on total dry weight of the composition. The retentate of step b is preferably treated by one or more microfiltration or diafiltration steps to obtain a MCC with increased protein content of at least 75 wt %.

According to another preferred embodiment, the present invention relates to the method, wherein the method further comprises the step e) of reducing the lactose content of the micellar casein concentrate to at most 5 wt %, preferably at most 1 wt %, more preferably at most 0.1 wt % based on total dry weight of the composition.

According to yet another preferred embodiment, the present invention relates to the method wherein the step e) is performed by membrane filtration, enzymatic treatment or liquid chromatography, or a combination thereof, preferably enzymatic treatment. Preferably the enzyme is of the β-galactosidase family (EC 3.2.1.23). Production of the liquid composition using the method of present invention including enzymatic treatment results in a product that has a reduced lactose content in combination with high protein content. Such a product may for example prove very valuable for patients that are known to suffer occasionally from temporary lactose intolerance after surgery. A medical drink that has high protein content and low lactose content would be beneficial for this group of patients.

According to a preferred embodiment, the present invention relates to the method, wherein the method further comprises a step f) of drying of the micellar casein concentrate to obtain non-bovine MCC powder.

According to yet another preferred embodiment, the present invention relates to the method wherein heating in step a) is comprised of pasteurization at a temperature of between 68 to 90° C., preferably 70 to 82° C., more preferably between 72 to 76° C.

Further advantages, features and details of the invention are elucidated on the basis of preferred embodiments thereof, wherein reference is made to the accompanying drawings and examples, in which:

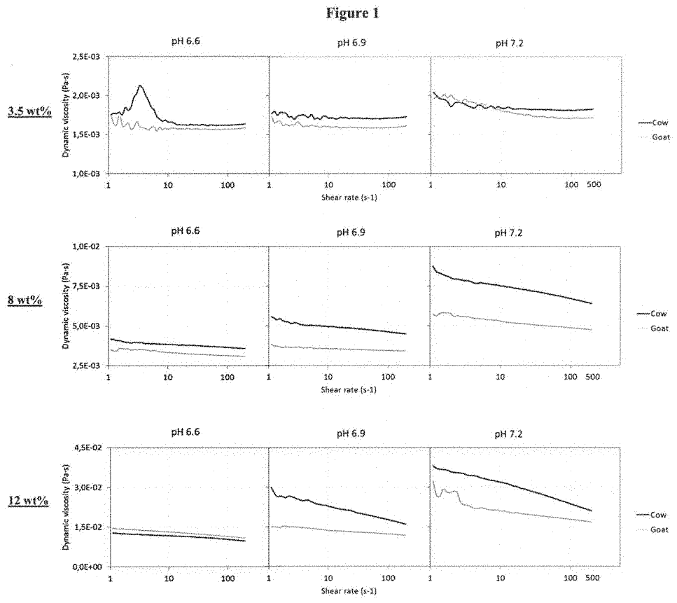

FIG. 1: shows the dynamic viscosities of the cow MCC and goat MCC solutions as a function of shear rate, protein content (3.5, 8 and 12 wt %) and pH. The viscosities were found to increase with protein concentration, as well as with increasing pH, as expected. The viscosities of the bovine and caprine samples were similar at 3.5% (m/m) protein content. The differences in viscosity became larger at higher concentrations, where the goat MCC solutions showed considerably lower viscosity than the corresponding cow MCC references.

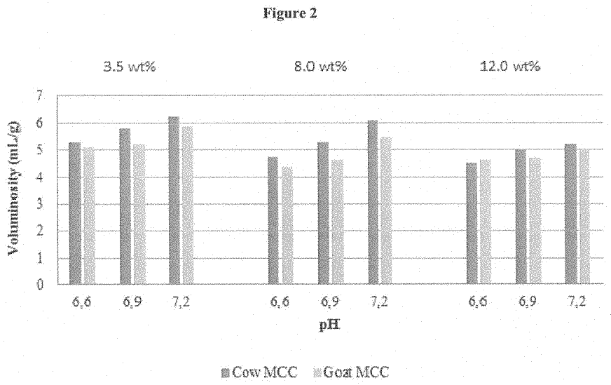

FIG. 2: shows the protein voluminosity of the cow MCC and goat MCC solutions at various pH and protein content, as determined with the Krieger-Dougherty formula based on the dynamic viscosities. The voluminosity of the goat MCC proteins were found to be lower than that of the cow MCC proteins, indicating a lower water-holding capacity of the goat milk proteins, particularly of the goat casein.

FIG. 3: shows the reducing SDS-PAGE gels obtained from skimmed goat milk treated at different temperatures. M: total sample, A: acid supernatant, R: rennet supernatant. C: fresh skimmed milk, 4: skimmed milk at 4° C., 70: skimmed milk treated at 70° C., 80: skimmed milk treated at 80° C., 90: skimmed milk treated at 90° C., P: pasteurized skimmed milk (80° C./15 s).

FIG. 4: shows the amount of soluble casein protein quantified in the different samples using ImageJ. Milk: fresh skimmed goat milk, Milk 70: skimmed goat milk treated at 70° C. for 10 minutes, Milk 80: skimmed goat milk treated at 80° C. for 10 minutes, Milk 90: skimmed goat milk treated at 90° C. for 10 minutes, Pasteurized goat Milk: skimmed milk treated at 80° C. for 15.

### EXAMPLES

Determination of viscosity and voluminosity of cow and goat micellar casein concentrate (MCC) Viscosity

To determine the viscosity and to calculate the voluminosity of goat and cow MCC solutions, goat MCC and cow MCC powders were reconstituted. In Tables 1, the amounts of ingredients necessary for preparing 100 g of goat MCC solution and of cow MCC solution, respectively, at 3.5, 8.0 and 12.0 (wt %) protein content and equivalent dry matter content are shown. The composition of the cow MCC was standardized using bovine ultrafiltration (UF) milk permeate to match both the protein and dry matter contents of the corresponding goat MCC solutions.

TABLE 1

| | | | | |
|---|---|---|---|---|
| | Milk | | | |
| cow MCC | Permeate | 10% NaN₃ | H₂O | Total |

100 g cow MCC solution at 3.5 wt % protein

| | | | | | |
|---|---|---|---|---|---|
| Amount (g) | 4.4 | 21.9 | 0.2 | 73.5 | 100 |
| Dry matter (%) | 4.3 | 1.2 | 0 | 0 | 5.5 |
| Protein (%) | 3.5 | 0 | 0 | 0 | 3.5 |

100 g cow MCC solution at 8 wt % protein

| | | | | | |
|---|---|---|---|---|---|
| Amount (g) | 10.1 | 75.1 | 0 | 9.7 | 100 |
| Dry matter (%) | 9.8 | 2.7 | 0 | 0 | 12.5 |
| Protein (%) | 8.0 | 0 | 0 | 0 | 8.0 |

100 g cow MCC solution at 12 wt % protein

| | | | | | |
|---|---|---|---|---|---|
| Amount (g) | 15.2 | 75.1 | 0 | 9.7 | 100 |
| Dry matter (%) | 14.7 | 4.0 | 0 | 0 | 18.7 |
| Protein (%) | 12.0 | 0 | 0 | 0 | 12.0 |

| | | | |
|---|---|---|---|
| goat MCC | 10% NaN₃ | H₂O | Total |

100 g goat MCC solution at 3.5 wt % protein

| | | | | |
|---|---|---|---|---|
| Amount (g) | 5.7 | 0.2 | 94.1 | 100 |
| Dry matter (%) | 5.5 | 0 | 0 | 5.5 |
| Protein (%) | 5.3 | 0 | 0 | 5.3 |

100 g goat MCC solution at 8 wt % protein

| | | | | |
|---|---|---|---|---|
| Amount (g) | 13.0 | 0.2 | 86.8 | 100 |
| Dry matter (%) | 12.5 | 0 | 0 | 12.5 |
| Protein (%) | 8.0 | 0 | 0 | 8.0 |

100 g goat MCC solution at 12 wt % protein

| | | | | |
|---|---|---|---|---|
| Amount (g) | 19.5 | 0.2 | 80.3 | 100 |
| Dry matter (%) | 18.7 | 0 | 0 | 18.7 |
| Protein (%) | 12.0 | 0 | 0 | 12.0 |

The powders were reconstituted overnight at approximately 5° C. to ensure proper rehydration. The natural pH value of the standardized cow MCC and goat MCC solutions reconstituted at 3.5 wt % protein content was about 6.9. Therefore the pH values of 6.6 (0.3 units below natural), 6.9 (natural) and 7.2 (0.3 units above natural) were selected for further experiments. For consistency of the results, the concentrated solutions at 8.0 and 12.0 wt % protein were also adjusted to the indicated pH values. The pH adjustment was performed using 1 M HCl or 1 M NaOH.

Viscosity of the various MCC solutions was measured at 20° C. as a function of shear rate on the upward curve from 1 to 200 s⁻¹, and again on the downward curve from 200 to 1 s⁻¹ with a rheometer using a cup-and-bob geometry. Mixtures of reverse osmosis (RO) and ultra filtration (UF) milk permeate were used to prepare solutions corresponding to the serum phase of each sample; the viscosity of these solutions was measured (ηₛ) and introduced into the Krieger-Dougherty formula to calculate protein voluminosity:

$$η = {η}_{s} \cdot {( 1 - \frac{φ}{{φ}_{max}} )}^{- 2.3 \cdot {φ}_{max}}$$

$$And$$

$$φ = {v}_{s} \cdot c$$

Where
η=dynamic viscosity of the solution (Pa·s);
ϕ=volume fraction of particles at measurement concentration;
ϕₘₐₓ=maximum volume fraction of particles;
ηₛ=dynamic viscosity of the serum phase (Pa·s);
2.5=shape factor for spherical particle;
vₛ=voluminosity (mL/g);
c=concentration (g/mL).

The viscosities of the cow MCC and goat MCC solutions were found to increase with protein concentration, as well as with increasing pH, as expected, see FIG. 1. The viscosities of the bovine and caprine samples were similar at 3.5 wt % protein content. The differences in viscosity became larger at higher concentrations, where the goat MCC solutions showed considerably lower viscosity than the corresponding cow MCC references. Results indicate that the goat MCC proteins have a lower viscosity contribution than their cow MCC counterparts at the same concentration and under the same experimental conditions. The viscosity of goat MCC was found to increase less than that of the bovine proteins with increasing pH, particularly at 8.0 and 12.0 wt % protein content.

Voluminosity

The voluminosity of the proteins was determined with the Krieger-Dougherty formula based on the dynamic viscosities of the whole solutions and the continuous phases (FIG. 2). Following a similar trend as observed for viscosity, the voluminosity of the goat MCC proteins were found to be lower than that of the cow MCC proteins.

Summarizing the above, these results indicate that goat MCC is a suitable ingredient for applications in high-protein products where a high viscosity is not desirable, e.g., medical and clinical beverages, sports and nutritional beverages, meal-replacement beverages, weight management beverages, smoothies, fat-reduced products by increasing protein. The voluminosity of the proteins from goat MCC is lower than that of the proteins from the cow MCC, indicating a lower water-holding capacity of the goat milk proteins, particularly of the goat casein.

Pasteurization Heat Treatment of Goat Milk and Determination of Protein Interaction

The influence on goat milk protein interaction from pasteurization heat treatment was examined with fresh skimmed goat milk and pasteurized skimmed goat milk obtained from Ausnutria (Ausnutria Ommen, The Netherlands). The samples were stored at 4° C. overnight. Three aliquots of fresh skimmed goat milk (10 mL) were transferred to individual plastic tubes and closed with a screw cap. The samples were heated at 70, 80 or 90° C. for 10 minutes using a water bath, after equilibrating the sample at the corresponding temperature for 3 minutes Immediately after heat treatment, the samples were cooled to room temperature using cold tap water. Pasteurized skimmed goat milk was obtained from the pasteurization process at 80° C. with a holding time of 15 seconds.

Protein separation was performed by fractionation of on six different milk samples: Fresh skimmed milk (C), fresh skim milk equilibrated at 4° C. (4), fresh skimmed milk heated at 70, 80 and 90° C. (70, 80 and 90 respectively), pasteurized skimmed milk (P). To determine the soluble casein fraction in the milk samples, the samples were treated according to the method described by Pesic et al. (2012), “Heat induced caseing whey protein interactions at natural pH of milk: A comparison between caprine and bovine milk”, Small Ruminant Research, 108(1), 77-86. In summary, the soluble casein fraction was separated from the micellar fraction (=insoluble fraction) using either acid precipitation (A) or rennet coagulation (R).

Acid Precipitation (A):

Dilute the samples (0.3 mL) by adding 0.6 mL of distilled water, and 30 μL of 10% (w/w) acetic acid. Mix for 10 minutes, then dilute by addition of 30 μL 1M sodium acetate, and 540 μL of distilled water. Mix for 10 minutes and centrifuge sample at 3000×g for 5 minutes to obtain the supernatant.

Rennet Coagulation (R):

Add 20 μL of rennet solution (4.4 IMCU) to 1000 μL of milk sample and incubate at 35° C. for 1 hour. Centrifuge sample at 3000×g for 10 minutes to obtain supernatant.

SDS Electrophoresis

The protein profile of each milk sample was assessed using reducing SDS-PAGE. Total milk samples were diluted to a final protein concentration of 4 μg/μL. To compare the supernatant samples with the milk samples on an equal basis, rennet supernatant was diluted with a final dilution factor of 7.5 (same as the milk samples), while the acid supernatant was diluted 1.65 times to obtain a final dilution factor of 7.5 using distilled water. Diluted samples were then diluted 4 times with NuPAGE SDS-reducing buffer (1 μg of protein/4, in the milk samples). Samples were loaded (10 μL) on to precast gels 12% Bis-TRIS (1.0 mm×15 well; Novex, Life Technologies, Carlsbad, Calif.) and run for 50 min at 200 V. The gels were then stained with 0.25% (wt/vol) SimplyBlue™ SafeStain and destained using distilled water.

Gel Quantification

Quantification of individual protein bands is obtained using the open source software ImageJ. The software used the colour intensity of the band to quantify the protein concentration. The soluble casein present in the rennet supernatant was quantified as percentage of the total casein content in the total fresh skimmed milk sample.

FIG. 3 shows the reducing SDS-PAGE gels and highlights the influence of heat treatment on the stability of whey proteins and soluble caseins in the serum phase of goat milk. The higher the temperature used in the heat treatment applied to the goat milk, the more aggregation within the micellar casein of the whey proteins are observed, resulting in a decrease of the corresponding band intensity in the rennet and acid supernatant samples. This decrease of intensity is most obvious in the rennet supernatant of the milk treated at 90° C. (R90), where only a faint band is visible for α-lactalbumin and β-lactoglobulin. It can also be observed that, similar to the whey proteins, the bands that correspond to the soluble caseins show a decrease in intensity with increasing severity of the heat treatment. Our hypothesis is that similar to the whey proteins, the soluble caseins are irreversibly bound to micellar casein due to the heat treatment.

Quantification of the intensity of the casein bands was performed in the rennet supernatant samples (R70, R80, R90 and Rp), and expressed as relative value to the total casein content determined in fresh skimmed milk. In FIG. 4, it can be observed that for fresh skimmed goat milk approximately 7.5% of the caseins are present in the soluble fraction. After heat treatment of goat milk, the soluble casein fraction was reduced to a minimum of 1.3% at 90° C./10 minutes. These results show that by adjusting the heat treatment, the fraction of soluble caseins can be modified accordingly. This effect is beneficial because the low soluble casein fraction obtained after the heat treatment will increase the efficiency of the filtration process by reducing the permeation of soluble casein. Therefore, decreasing of soluble casein fraction in (skimmed) goat milk by heat treatment (e.g. pasteurization) will increase the yield of casein retention during the microfiltration process.

The present invention is by no means limited to the above described preferred embodiments thereof. The rights sought are defined by the following clauses within the scope of which many modifications can be envisaged.

1. A=liquid composition comprising:
a micellar casein concentrate (MCC) of goat origin,
wherein the MCC comprises between 60 to 90 wt % protein, based on total dry weight of the composition,
wherein the composition has a dynamic viscosity of at most 100 mPa·s,
wherein the MCC comprises a casein to whey ratio of at least 85:15, and
wherein the composition has a pH of between 6.5 to 7.2.

2. The liquid composition according to claim 1, wherein the MCC further comprises less than 50 wt %, of lactose based on total dry weight of the composition.

3. The liquid composition according to claim 1, wherein the MCC further comprises a surfactant and/or emulsifying agent.

4. A flood product,
wherein said food product is a powder comprised of a micellar casein concentrate (MCC) of goat origin,
wherein the MCC comprises between 30 to 90 wt % protein, based on total dry weight of the MCC,
wherein the MCC comprises a casein to whey ratio of at least 85:15 and has a pH of between 6.5 to 7.2, and
wherein the food product comprises at least 8 wt % protein based on total dry weight of the food product.

5. The flood product according to claim 4, wherein the MCC comprises less than 1 wt % of lactose based on total dry weight of the MCC.

6. The flood product according to claim 4, wherein the food product is one or more selected from the group consisting of instant powder formulations, infant formula, sport drinks, medical nutrition, elderly nutrition, and tube feeding.

7. A method for production of the liquid composition according to claim 1, wherein the method comprises the steps of,
a) heat treating goat milk, wherein the goat milk has a fat content of at most 0.1 wt %, and wherein by heat treating a soluble casein fraction of the goat milk is reduced to a concentration of between 1 to 6%, based on the total casein content in the milk.
b) microfiltrating the heat treated goat milk providing a permeate and a retentate, wherein the retentate comprises a micellar casein concentrate, and
c) collecting the retentate comprised of the micellar casein concentrate.

8. The method according to claim 7, wherein the method further comprises at least one additional step d) of concentrating the retentate of step b) to obtain a micellar casein concentrate comprised of at least 75 wt % protein, based on total dry weight of the composition.

9. The method according to claim 7, wherein the method further comprises the step e) of reducing the lactose content of the micellar casein concentrate to at most 5 wt %, preferably at most 1 wt %, more preferably at most 0.1 wt % based on total dry weight of the composition.

10. The method according to claim 9, wherein the step e) is performed by membrane filtration, enzymatic treatment or liquid chromatography, or a combination thereof.

11. The method according to claim 7, wherein the method further comprises a step f) drying of the micellar casein concentrate to obtain goat MCC powder.

12. The method according to claim 7, wherein heating in step a) is comprised of pasteurization at a temperature of between 68 to 90° C., preferably 70 to 82° C., more preferably between 72 to 76° C.

13. The liquid composition according to claim 2, wherein the MCC further comprises a surfactant and/or emulsifying agent.

14. The food product according to claim 5, wherein the food product is one or more selected from the group consisting of instant powder formulations, infant formula, sport drinks, medical nutrition, elderly nutrition, and tube feeding.

15. The method according to claim 8, wherein the method further comprises the step e) of reducing the lactose content of the micellar casein concentrate to at most 5 wt % based on total dry weight of the composition.

16. The method according to claim 15, wherein the step e) is performed by membrane filtration, enzymatic treatment or liquid chromatography, or a combination thereof.

17. The method according to claim 15, wherein the method further comprises a step f) drying of the micellar casein concentrate to obtain goat MCC powder.

18. The method according to claim 16, wherein the method further comprises a step f) drying of the micellar casein concentrate to obtain goat MCC powder.

19. The method according to claim 8, wherein the heating in step a) is comprised of pasteurization at a temperature of between 68 to 90° C.

20. The method according to claim 18, wherein heating in step a) is comprised of pasteurization at a temperature of between 68 to 90° C.
